(19) United States
(12) Patent Application Publication
(10) Pub. No.: US 2014/0197260 A1
(43) Pub. Date: Jul. 17, 2014

(54) VERTICAL MILL

(71) Applicants: Kensuke Futahashi, Tokyo (JP); Hiroyuki Kanazawa, Tokyo (JP); Shin Asano, Tokyo (JP); Tomoaki Inoue, Tokyo (JP)

(72) Inventors: Kensuke Futahashi, Tokyo (JP); Hiroyuki Kanazawa, Tokyo (JP); Shin Asano, Tokyo (JP); Tomoaki Inoue, Tokyo (JP)

(73) Assignee: MITSUBISHI HEAVY INDUSTRIES, LTD., Tokyo (JP)

(21) Appl. No.: 14/236,019

(22) PCT Filed: Sep. 6, 2012
(86) PCT No.: PCT/JP2012/072755

§ 371 Date: Jan. 29, 2014

(30) Foreign Application Priority Data
Sep. 22, 2011 (JP) 2011-208098

(51) Int. Cl. B02C 15/04

(52) U.S. Cl. CPC B02C 15/04
USPC 241/117

(57) ABSTRACT

In a vertical mill, a mill table is supported in a housing by a support shaft center, which is along a vertical direction, in such a manner as to be driven and rotated, and above the mill table, a mill roller is rotatably supported by a first support shaft, and the mill roller is capable of rotating the mill table in such a manner that an external peripheral surface of the mill roller comes into contact with an upper surface of the mill table, and a support arm configured to support the first support shaft is swingably supported on the housing by a second support shaft, in such a manner that the mill roller can come close to or move away from the mill table, and a reaction force load giving device is provided that has a dumper filled with a magnetorheological fluid and magnetizes the magnetorheological fluid.

### FIELD

The present invention relates to a vertical mill for milling and pulverizing a solid object such as coal and biomass.

### BACKGROUND

In combustion equipment such as boiler electric power generation, solid fuel such as coal and biomass is used as fuel. When this coal is used as solid fuel, for example, raw coal is milled by a vertical mill to generate powdered coal, and the obtained powdered coal is used as fuel.

This vertical mill is configured such that a mill table is provided at a lower portion of a housing so that the mill table can be driven and rotated, and multiple mill rollers are provided at an upper surface of the mill table in such a manner that the mill rollers can rotate therewith and can give milling load. Accordingly, when raw coal is provided from a coal feeding pipe onto the mill table, the coal is dispersed on the entire surface due to centrifugal force and a coal layer is formed, and each mill roller presses the coal layer so as to mill the coal, and powdered coals that are dried by provided air and classified are discharged to the outside.

It should be noted that such vertical mills are suggested, for example, in Patent Literatures 1, 2 shown below.

### CITATION LIST

### Patent Literature

Patent Literature 1: Japanese Laid-open Patent Publication No. 09-047680

Patent Literature 2: Japanese Patent Application Laid-open No. 2001-017880

### SUMMARY

### Technical Problem

In the conventional vertical mill explained above, the mill roller is pressed onto the rotating mill table with a predetermined load, and a lump of coal is provided between the mill rollers and the mill table, whereby the coal is pressurized and broken to be made into powdered coal. In this case, the mill roller is rotatably supported by a support arm with a bearing, and the support arm is supported in a rotatable manner in a direction in which the mill roller pressurizes the mill table, and a pressing device is attached to the support arm so as to give load for causing the mill roller to pressurize the mill table. A spring and a hydraulic dumper are used as this pressing device.

However, when the vertical mill uses a mechanical spring such as a coil spring as a pressing device for urging the support arm so as to cause the mill roller to pressurize the mill table, the device configuration can be made simpler, but on the other hand, the dumping effect is small, and this increases the vibration caused when the coal is pressurized and broken, thus being a vibration oscillation source for another structural object, which causes noises and reduction of durability. On the other hand, when a hydraulic dumper is used as a pressing device, a high degree of reduction effect can be obtained, but this requires peripheral equipment such as an accumulator, pipes, a valve, and a pump, which makes the system complicated, and reduces the reliability and increases the cost.

The present invention is made to solve the above problems, and it is an object of the present invention to provide a vertical mill which is capable of suppressing the increase in the size of the device and the increase in complexity of the device but still capable of suppressing generation of noises and degradation of the durability.

### Solution to Problem

According to an aspect of the present invention in order to achieve the object, there is provided, a vertical mill including: a housing having a hollow shape; a mill table rotatably supported in the housing by a support shaft center along a vertical direction; a mill roller provided above the mill table and rotatably supported by a first support shaft, the mill roller being rotatable with an external peripheral surface of the mill roller coming into contact with an upper surface of the mill table; a support arm for supporting the first support shaft, the support arm being swingably supported on the housing by a second support shaft with the external peripheral surface of the mill roller coming close to or moving away from the upper surface of the mill table; and a reaction force load giving device having a dumper filled with a magnetorheological fluid and magnetizing the magnetorheological fluid so as to give a reaction force load to the mill roller via the support arm, the reaction force load being given against a direction in which the mill roller moves away from the mill table.

Therefore, when a solid object enters into between the mill roller and the mill table, the rotation force of the mill table is transmitted to the mill roller via the solid object and the mill table rotates therewith, and at this occasion, the mill roller tries to ascend due to the solid object entering thereinto, but a reaction force load giving device gives reaction force load to the mill roller, and therefore, the mill roller can mill the solid object by giving pressurizing load to the solid object. In this case, the reaction force load giving device is constituted with the dumped filled with the magnetorheological fluid, and therefore, desired reaction force load can be ensured by just magnetizing the magnetorheological fluid by applying the magnetic field to the magnetorheological fluid, and thus the increase in the size of the device and the increase in complexity of the device can be suppressed but generation of noises and degradation of the durability can still be suppressed.

According to an another aspect of the present invention, there is provided the vertical mill, wherein the mill roller is provided with a returning device for returning the mill roller back to an initial position where the mill roller is close to the mill table.

Therefore, after the mill roller ascends due to the solid object, the mill roller is returned back to the initial position by the returning device, and therefore, the mill roller can mill the solid object by giving the pressing load to the solid object at all times.

According to a still another aspect of the present invention, there is provided the vertical mill including: a detection device for detecting a position of the mill roller with respect to the mill table or a pressing load of the mill roller onto the mill table; and a control device for increasing the reaction force load given by the reaction force load giving device in accordance with increase of a detection value of the detection device.

Therefore, when the position of the mill roller with respect to the mill table rises, or when the pressing load of the mill roller onto the mill table increases, the control device increases the reaction force load of the mill roller, and therefore, appropriate pressing load cars be given in accordance with the size and hardness of the solid object.

According to a still another aspect of the present invention, these is provided the vertical mill, wherein when the detection value of the detection device is more than a predetermined value which has been set in advance, the control device is configured to reduce the reaction force load given by the reaction force load giving device so that the reaction force load given by the reaction force load giving device is less than a reference value which has been set in advance.

Therefore, when the foreign object that cannot be milled enters into between the mill roller and the mill table, the position of the mill roller with respect to the mill table ascends to a position to be higher than the predetermined value, or the pressing load of the mill roller with respect to the mill table increases to be more than the predetermined value, and therefore, at this occasion, the reaction force load of the mill roller is reduced to be less than the upper limit value, so that the mill roller and the mill table can be prevented from being damaged.

According to a still another aspect of the present invention, there is provided the vertical mill, wherein when a vibration of the mil roller enters into a resonance range, the control device is configured to increase a reaction force load given by the reaction force load giving device.

Therefore, when the vibration of the mill roller enters into the resonance range, the reaction force load is increased, so that the mill roller and the still table are prevented from being damaged by suppressing the vibration of the mill roller and the mill table.

According to a still another aspect of the present invention, there is provided the vertical mill, wherein a plurality of mill rollers and support arms are provided with a regular interval along a peripheral direction of the mill table, and the reaction force load giving device is configured to differentiate reaction force loads of the plurality of mill rollers.

Therefore, multiple mill rollers have different reaction force loads, so that appropriate pressing loads can be given to solid objects of which sizes and hardness are different.

### Advantageous Effects of Invention

According to the vertical mill of the present invention, the mill roller is provided that can rotate together with the mill table, and the reaction force load giving device is provided for giving the reaction force load to the mill roller, and therefore, the reaction force load is given to the mill roller, and the solid object can be milled appropriately. In addition, the dumper filled with the magnetorheological fluid is provided as the reaction force load giving device, so that desired reaction force load can be ensured by just magnetizing the magnetorheological fluid, and thus the increase in the size of the device and the increase in complexity of the device can be suppressed but generation of noises and degradation of the durability can still be suppressed.

### BRIEF DESCRIPTION OF DRAWINGS

FIG. 1 is a schematic configuration diagram illustrating a vertical mill according to a first embodiment of the present invention.

FIG. 2 is a top view illustrating arrangement of mill rollers provided in the vertical mill of the first embodiment.

FIG. 3 is a schematic diagram illustrating a support structure of a mill roller provided in the vertical mill according to the first embodiment.

FIG. 4 is a schematic diagram illustrating a pressing device of the mill roller provided in the vertical mill according to the first embodiment.

FIG. 5 is a flowchart illustrating processing for setting reaction force load of the mill roller provided in the vertical mill according to the first embodiment.

FIG. 6 is a graph illustrating the reaction force load of the mill roller imposed on the pivot angle of the support arm in the vertical mill according to the first embodiment.

FIG. 7 is a schematic diagram illustrating a support structure of a mill roller provided in a vertical mill according to a second embodiment of the present invention.

FIG. 8 is a graph illustrating the reaction force load of a mill roller imposed on the pivot angle of a support arm in a vertical mill according to a third embodiment of the present invention.

FIG. 9 is a schematic diagram illustrating a support structure of a mill roller in a vertical mill according to a fourth embodiment of the present invention.

FIG. 10 is a flowchart illustrating processing for setting reaction force load of a mill roller provided in a vertical mill according to the fourth embodiment.

FIG. 11 is a graph illustrating amplitude with respect to a vibration frequency of a mill roller provided in a vertical mill according to a fifth embodiment of the present invention.

### DESCRIPTION OF EMBODIMENTS

Hereinafter, preferred embodiments of a vertical mill according to the present invention will be hereinafter described in detail with reference to attached drawings. It should be noted that the present invention is not limited by the embodiments, and when there are multiple embodiments, an embodiment made by combining embodiments is also included.

### First Embodiment

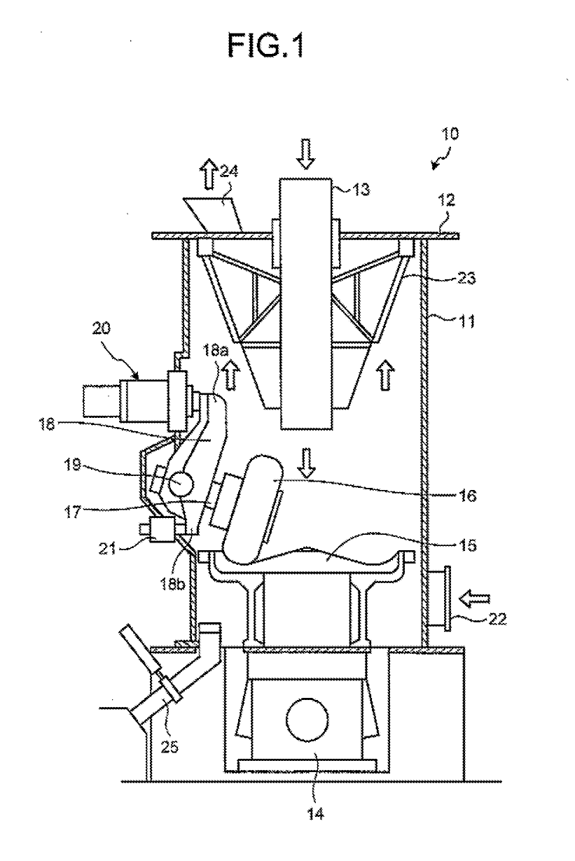

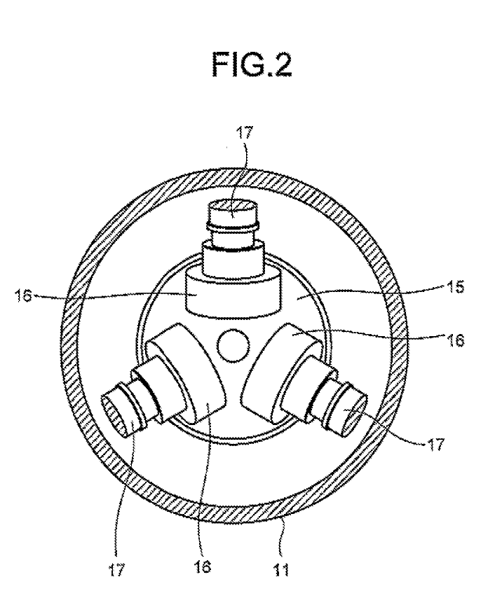

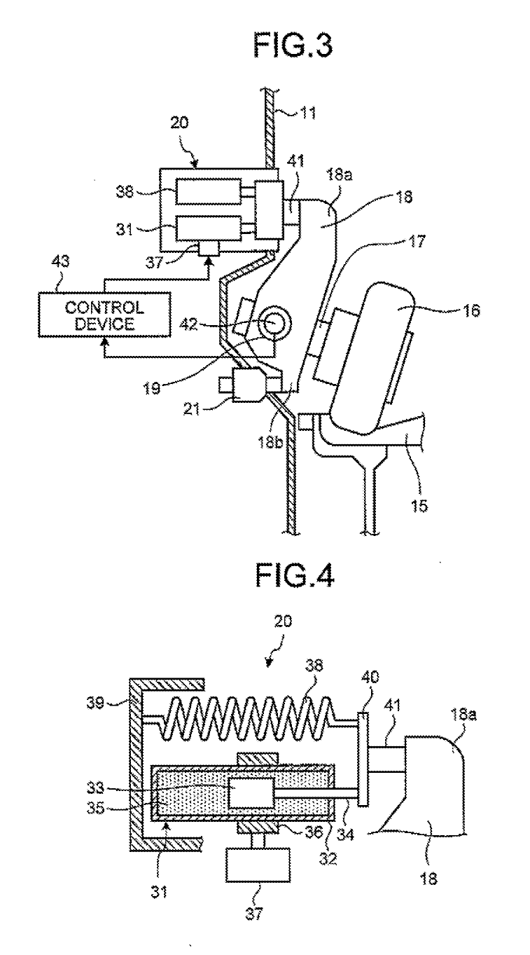

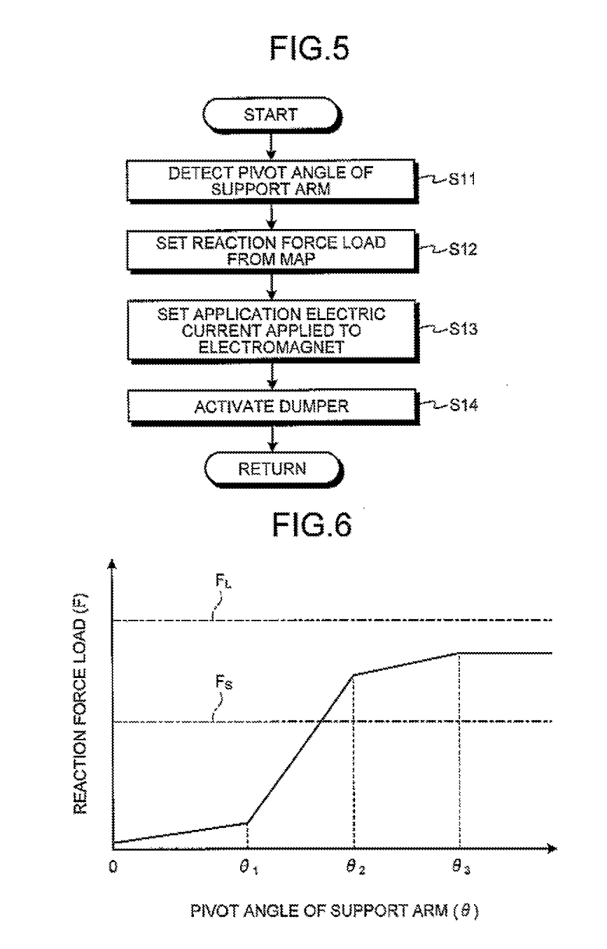

FIG. 1 is a schematic configuration diagram illustrating a vertical mill according to a first embodiment of the present invention. FIG. 2 is a top view illustrating arrangement of mill rollers provided in the vertical mill of the first embodiment. FIG. 3 is a schematic diagram illustrating a support structure or a mill roller provided in the vertical mill according to the first embodiment. FIG. 4 is a schematic diagram illustrating a pressing device of the mill roller provided in the vertical mill according to the first embodiment. FIG. 5 is a flowchart illustrating processing for setting reaction force load of the mill roller provided in the vertical mill according to the first embodiment. FIG. 6 is a graph illustrating the reaction force load of the mill roller imposed on the pivot angle of the support arm in the vertical mill according to the first embodiment.

The vertical mill according to the first embodiment is to mill solid objects such as coal (raw coal) and biomass. In this case, the biomass is organic resources derived from renewable living things, which are, for example, thinned wood, waste wood, driftwood, grasses, wastes, sludge, tires, and recycles fuel (such as pellets and chips) derived therefrom, but the biomass is not limited to what has been enumerated herein.

In a vertical mill 10 according to the first embodiment, as shown in FIG. 1 and FIG. 2, a housing 11 is in a vertical cylindrical hollow shape, and a solid object providing pipe 13 is attached to a central portion of a ceiling portion 12. This solid object providing pipe 13 is to provide solid objects from a solid object providing device, not shown, into the housing 11, and the solid object providing pipe 13 is provided along the upper/lower direction (vertical direction) at the central position of the housing 11. The lower end portion of the solid object providing pipe 13 extends to the lower side.

The housing 11 is provided with a base 14 at the lower portion thereof, and a mill table 15 is provided on this base 14 in a rotatable manner. This mill table 13 is provided at the central position of the housing 11 in such a manner as to oppose the lower end portion of the solid object providing pipe 13. The mill table 15 is configured to be rotatable about the axial center in the upper/lower direction (vertical direction), and can be driven and rotated by a driving device, not shown. The mill table 15 is in an inclined shape such that the mill table 15 is high in the central portion and becomes lower toward the outer side, and the external peripheral portion of the mill table 15 is bent upward.

The mill table 15 is provided with multiple mill rollers 16 (in the present embodiment, three mill rollers 16) so as to face the upper side. The mill rollers 16 are arranged with a regular interval therebetween in the peripheral direction above the external peripheral portion of the mill table 15. Multiple first support shafts 17 (in the present embodiment, three first support shafts 17) are arranged to incline downward from the sidewall of the housing 11 to the central portion side, and the mill rollers 16 are rotatably supported by means of bearings (not shown) at the distal and portions. More specifically, each of the mill rollers 16 is supported rotatably in such a state that the upper portion of the mill roller 16 is inclined to the central portion side of the housing 11 above the mill table 15.

Multiple support arms 18 (in the present embodiment, three support arms 18) are supported on a sidewall of the housing 11 by second support shafts 19, of which middle portion is along the horizontal direction, so as to be able to swing in the vertical direction. Each of the support arms 18 supports the base end portion of the first support shaft 17 of which distal end portion is attached to the mill roller 16. More specifically, when each of the support arms 18 swings in a vertical direction with the second support shaft 19 being a fulcrum, each of the mill rollers 16 is supported in such a manner as to be able to come close to or move away from the upper surface of the mill table 15. When the mill table 15 rotates while the external peripheral surface of each of the mill rollers 16 is in contact with the upper surface of the mil table 15, each of the mill rollers 16 can rotate together therewith by receiving rotation force from the mill table 15.

Each of the support arms 18 is provided with a reaction force load giving device 20 for giving reaction force load of each of the mill rollers 16 to an upper end portion 18a, and each of the support arms 18 is also provided with a stopper 21 for a lower end portion 18b. This reaction force load giving device 20 is to cause the support arm 18 to give the reaction force load to the mill roller 16, wherein the reaction force load is in a direction against the direction in which the mill roller 16 moves away from the mill table 15, which will be explained later. The stopper 21 is to restrict the amount of downward pivot movement of the mill roller 16 using the support arm 18. The reaction force load giving device 20 and the stopper 21 are provided on the housing 11.

Each of the mill rollers 16 is to mill solid object between the mill roller 16 and the mill table 15, and it is necessary to ensure a predetermined gap between the external peripheral surface of the mill roller 16 and the upper surface of the mill table 15, and it is necessary to exert a predetermined pressing load onto the solid object. For this reason, by causing the stopper 21 to restrict the pivot position (initial position) of the support arm 18, a predetermined gap is ensured so that the solid object can be taken into the gap between the external peripheral surface of the mill roller 16 and the upper surface of the mill table 15 and can be milled. In addition, the reaction force load giving device 20 gives the reaction force load which is in a direction against the direction in which the mill roller 16 moves away from the mill table 15, so that, when the solid object enters into the gap between the mill roller 16 and the mill table 15, the mill roller 16 is prevented from ascending, and the solid object is milled.

More specifically, when the solid object is provided to the central portion of the mill table 15, this solid object moves to the external peripheral side due to the centrifugal force, and the solid object enters into the gap between each of the mill rollers 16 and the mill fable 15. In this case, each of the mill rollers 16 tries to ascend due to the solid object, but the reaction force load giving device 20 gives the reaction force load, and accordingly, each of the mill rollers 16 does not ascend, and the pressing load is given to the solid object. In this case, the rotation force is transmitted from the mill table 15 via the solid object to the mill roller 16, whereby the mill roller 16 rotates, and at the same time, the pressing load is exerted on the solid object, so that the solid object can be milled.

The housing 11 is provided with an inlet port 22 which is at a lower portion of the housing 11 and which is around the external peripheral side of the mill table 15, wherein primary air is blown through the inlet port 22. The housing 11 is provided with a rotary separator (classification device) 23 which is at an upper portion of the housing 11 and which is around the external peripheral side of the solid object providing pipe 13, wherein the rotary separator (classification device) 23 classifies the milled solid objects (hereinafter referred to as milled objects), and the housing 11 is also provided with an outlet port 24 at the ceiling portion 12, wherein the outlet port 24 discharges the milled objects which have been classified. Further, the housing 11 is provided with a foreign object discharge pipe 25 at a lower portion of the housing 11, wherein this foreign object discharge pipe 25 discharges foreign objects (spillages) such as stones and metal pieces mixed in the solid objects by dropping them from the external peripheral portion of the mill table 15.

Hereinafter, the reaction force load giving device 20 will be explained in detail. As shown in FIG. 3 and FIG. 4, the reaction force load giving device 20 includes a dumper 31 filled with magnetorheological fluid, and the reaction force load is given to the mill roller 16 by magnetizing this magnetorheological fluid. This dumper 31 includes a cylinder 32 forming a hollow shape, a piston 33 that can freely move within the cylinder 32, and a rod 34 one end portion of which is fixed to the piston 33 and the other end portion of which extends to the outside from the cylinder 32, wherein a magnetorheological fluid (MR fluid) 33 is filled in the cylinder 32. An electromagnet (coil) 36 is provided at the external peripheral portion of the cylinder 32 facing the piston 33, and a power supply device 37 is connected to this electromagnet 36.

Therefore, when the power supply device 37 does not apply electric current to the electromagnet 36, the magnetorheological fluid 35 is in the non-magnetized state, and therefore, the piston 33 can move without hardly any resistance. On the other hand, when the power supply device 37 applies electric current to the electromagnet 36, the magnetorheological fluid 35 is in the magnetized state, and therefore, binding force is generated between particles which increases the viscosity, and when the piston 33 moves, a predetermined resistance force, i.e., the reaction force load, is exerted.

The reaction force load giving device 20 includes not only the dumper 31 but also a compression coil spring 33 serving as a returning device for returning the mill roller 16 back to the initial position where the mill roller 16 is close to the mill table 15. The dumper 32 and the compression coil spring 38 are arranged in a parallel state, one end portion of the compression coil spring 38 and the cylinder 32 of the dumper 31 is coupled with a casing 39 forming the hollow shape, and this casing 39 is fixed to the housing 11. On the other hand, the other end portion of the compression coil spring 38 and the rod 34 of the dumper 31 is coupled with a coupling member 40, and a pressing unit 41 of the coupling member 40 is in contact with the upper end portion 18a of the support arm 18. More specifically, the compression coil spring 33 urges and supports the support arm 18 in the clockwise direction in FIG. 3, i.e., the direction in which the mill roller 16 comes closer to the mill table 15.

In this embodiment, the compression coil spring 38 is provided as the returning device for returning the mill roller 16 back to the initial position where the mill roller 16 is close to the mill table 15, the mill roller 16 can return back to the initial position by its own weight, and therefore, the urging force of the compression coil spring 38 may be of such a size that the activated dumper 31 can be returned back to the original position, i.e., the position where the pressing unit 41 is in contact with the upper end portion 18a of the support arm 18. When the coupling member 40 and the upper end portion 18a of the support arm 18 are coupled without providing the pressing unit 41 on the coupling member 40, the support arm 18 returns back to the initial position due to the weight of the mill roller 16 and the like, and therefore, the returning device (compression coil spring 38) may be omitted.

Between the support arm 18 and the second support shaft 19, a pivot angle sensor (detection device) 42 is provided to detect the pivot angle of the support arm 18. A control device 43 controls the reaction force load giving device 20 on the basis of the detection value of the pivot angle sensor 42, and adjusts the reaction force load of the mill roller 16. More specifically, when the pivot angle of the support arm 18 with respect to the initial position increases, i.e., when the mill roller 16 ascends from the initial position with respect to the mill table 15, then, the control device 43 increases the reaction force load of the mill roller 16.

Here specifically, when the solid object enters into the gap between the mill roller 16 and the mill table 15, the mill roller 16 ascends due to this solid object, and at this occasion, the larger the solid object is, the larger the amount of ascend of the mill roller 16 is. This means that, when the solid object is larger, the mill roller 16 requires a large pressing load for milling, this solid object. For this reason, when the amount of ascend of the mill roller 16 is larger, the reaction force load of the mill roller 16 by the reaction force load giving device 20 is increased, so that, regardless of the size of the solid object, the solid object can be appropriately milled.

In the above explanation, the pivot angle sensor 42 for detecting the pivot angle of the support arm 18 is used as the detection device, but the invention is not limited thereto. For example, a load sensor (load cell) for detecting the pressing load of the mill roller 16 onto the mill table 15 may be used as the detection device.

The reaction force load giving device 20 is the dumper 31 filled with the magnetorheological fluid 35, and is activated by magnetizing the magnetorheological fluid 35, and therefore, this may magnetize various kinds of devices therearound to attract particle dust included in the solid object (raw coal). For this reason, it is preferable to provide the dust-preventing device for preventing the particle dust included in the solid object provided onto the mill table 15 (magnetorheological body) from entering into the dumper 31 constituting the reaction force load giving device 20. For example, as this dust-preventing device, at least the pressing unit 41 serving as the driving rod may be made of the non-magnetorheological body. The non-magnetorheological member constituting the non-magnetorheological body may be, for example, stainless steel (SUS) and synthetic resin. As the dust-preventing device, at least the pressing unit 41 may be made of the non-magnetorheological member, but preferably, the rod 34 and the cylinder 32 of the dumper 31, the coupling member 40, the first support shaft 11, the support arm 18, and the second support shaft 19 may be made of the non-magnetorheological member.

In this case, the action of the vertical mill 10 according to the first embodiment explained above, and especially, the setting control of the reaction force load will be explained in detail with reference to the overall diagram of FIG. 1 and the flowchart of FIG. 5.

In the vertical mill 10, when the solid object such as raw coal is provided from the solid object providing pipe 13 into the housing 11 as shown in FIG. 1, this solid object is provided to the central portion on the mill table 15. At this occasion, the mill table 15 rotates with a predetermined speed, and therefore, the solid object provided to the central portion en the mill table 15 disperses and moves to the external periphery by the centrifugal force, and the certain solid object layer is formed on the entire surface of the mill table 15. More specifically, the solid object enters into between each of the mill rollers 16 and the mill table 15.

Then, the rotation force of the mill table 15 is transmitted via the solid object to each of the mill rollers 16, and according to the rotation of the mill table 15, the mill roller 16 rotates. At this occasion, each of the mill rollers 16 tries to ascend due to the solid object, but because the reaction force load giving device 20 gives the reaction force load, the ascending operation is suppressed, and the pressing load is given to the solid object. Therefore, each of the mill rollers 16 presses and mills the solid object on the mill table 15. It should be noted that although each of the mill rollers 16 slightly ascends against the reaction force load depending on the size and the hardness of the solid object entering into between the mill roller 16 and the mill table 15, each of the mill rollers 16 is returned back to the initial position due to the weight of the mill roller 16 of its own and the urging force of the compression coil spring 38.

When the mill roller 16 mills the solid object as described above, the control device 43 controls the reaction force load giving device 20 on the basis of the detection value of the rotation position sensor 42, and adjusts the reaction force load of the mill roller 16. More specifically, as illustrated in FIG. 5, in step S11, the rotation position sensor 42 detects the pivot angle of the support arm 18, and in step S12, the control device 43 sets the reaction force load of the mill roller 16 on the basis of the pivot angle of the support arm 18.

In this case, the control device 43 uses the map of FIG. 6 to set the reaction force load of the mill roller 16. More specifically, as illustrated in FIG. 6, as the pivot angle (the amount of ascend of the mill roller 16) θ of the support arm 18 becomes larger, the reaction force load F of the mill roller 16 given by the reaction force load giving device 20 is configured to be larger. In this map, when the pivot angle of the support arm 18 is less than a pivot angle θ₁, the increasing rate of the reaction force load F is small, and when the pivot angle of the support arm 18 is within pivot angles θ₁ to θ₂, the increasing rate of the reaction force load F is configured to be large. Thereafter, when the pivot angle of the support arm 18 is pivot angles θ₂ to θ₃, the increasing rate of the reaction force load F is small, and when the pivot angle of the support arm 18 is more than the pivot angle θ₃, the reaction force load F is configured to be constant. In this case, the reaction force load F with which the mill roller 16 can mill the solid object is the reaction force load F_{S}, and therefore, the increasing rate of the reaction force load F is configured to be large when the pivot angle of the support arm 18 is pivot angles θ₁ to θ₂. The upper limit value of the reaction force load F at which the mill roller 16 may be damaged is the reaction force load F_{L}, and therefore, the reaction force load F is configured such that when the pivot angle of the support arm 18 is pivot angles θ₂ to θ₃, the increasing rate of the reaction force load F is small, and when the pivot angle of the support arm 18 is more than the pivot angle θ₃, the reaction force load F is configured to be constant.

Then, back to FIG. 5, when the reaction force load of the mill roller 16 has been set in step S12, the reaction force load giving device 20 sets the application electric current applied by the power supply device 37 to the electromagnet 36 in step S13. It should be noted that the application electric current applied to the electromagnet 36 by the power supply device 37 with respect to the reaction force load of the mill roller 16 may be obtained in advance through experiment and the like, and may be made into a map as necessary. Then, in step S14, the control device 43 controls the power supply device 37 and applies a predetermined electric current to the electromagnet 36, so that the magnetorheological fluid 35 is magnetized and the dumper 31 is activated, and the predetermined reaction force load is exerted on the mill roller 16.

In this case, when the solid object enters into between each of the mill rollers 16 and the mill table 15, the mill roller 16 ascends, and accordingly, the reaction force load of the mill roller 16 increases, and the solid object is milled by giving the pressing load to the solid object. When the mill roller 16 mills the solid object, the mill roller 16 descends, and therefore the reaction force load of the mill roller 16 decreases, and the mill roller 16 returns back to the initial position by its own weight, and the support arm 18 returns back to the initial position due to the urging force of the compression coil spring 38. As a result of the repetition thereof, the mill roller 16 mills the solid object continuously.

Thereafter, the solid object milled by the mill rollers 16 are made into milled objects, and the milled objects ascend while the milled objects are dried by the primary air blown into the housing 11 through the inlet port 22. The milled objects ascended are classified by the rotary separator 23, and coarse particles drop and are returned back onto the mill table 15 again, so that they are milled again. On the other hand, fine particles pass through the rotary separator 23, and are discharged through the outlet port 24 with the air blow. The spillages such as stones and metal pieces mixed in the solid objects drop from the external peripheral portion to the outside due to the centrifugal force of the mill table 15, and the spillages are discharged by the foreign object discharge pipe 25.

As described above, the vertical mill according to the first embodiment is configured such that the mill table 15 is supported, in such a manner as to be driven and rotated, by the support shaft center along the vertical direction in the housing 11, and above the mill table 15, the mill rollers 16 are rotatably supported by the first support shaft 17, and the external peripheral surface is in contact with the upper surface of the mill table 15 so as to allow the mill table 15 to rotate together therewith, and the support arm 18 supporting the first support shaft 17 is swingably supported on the housing 11 by the second support shaft 19 so that the mill roller 16 can come close to or move away from the mill table 15, and the reaction force load giving device 20 is provided that has the dumper 31 filled with the magnetorheological fluid 35, wherein by magnetizing the magnetorheological fluid 35, the reaction force load giving device 20 causes the support arm 18 to give the reaction force load to the mill roller 16 against the direction in which the mill roller 16 moves away from the mill table 15.

Therefore, when the solid object enters into between the mill roller 16 and the mill table 15, the rotation force of the mill table 15 is transmitted via the solid object to the mill roller 16, so that the mill roller 16 rotates together therewith, and at this occasion, the mill roller 16 tries to ascend due to the entrance of the solid object, but since the reaction force load giving device 20 gives the reaction forge load to the mill roller 16, the mill roller 16 can mill the solid object by giving the pressing load to the solid object. In this case, the reaction force load giving device 20 is constituted by the dumper 31 filled with the magnetorheological fluid 35, and therefore, desired reaction force load can be ensured by applying the magnetic field to the magnetorheological fluid 35 and magnetizing the magnetorheological fluid 35, thus capable of suppressing the increase in the size of the device and the increase in complexity but still capable of suppressing generation of noises and reduction of the durability.

In addition, the vertical mill according to the first embodiment is provided with the compression coil spring 38 serving as the returning device for returning the mill roller 16 back to the initial position where the mill roller 16 is close to the mill table 15. Therefore, after the mill roller 15 ascends due to the solid object, the mill roller 16 is returned back to the initial position by the compression coil spring 38, and therefore, the mill roller 16 can mill the solid object by giving the pressing load to the solid object at all times.

The vertical mill according to the first embodiment is provided with the pivot angle detection sensor 42 for detecting the pivot angle of the support arm 18, which serves as the detection device for detecting the position of the mill roller 16 with respect to the mill table 15, and the control device 43 increases the reaction force load given by the reaction force load giving device 20 in accordance with the increase of the detection value of the pivot angle detection sensor 42. Therefore, when the mill roller 16 ascends with respect to the mill table 15, the control device 43 increases the reaction force load of the mill roller 16, and therefore, an appropriate pressing load can be given in accordance with the size and the hardness of the solid object.

### Second Embodiment

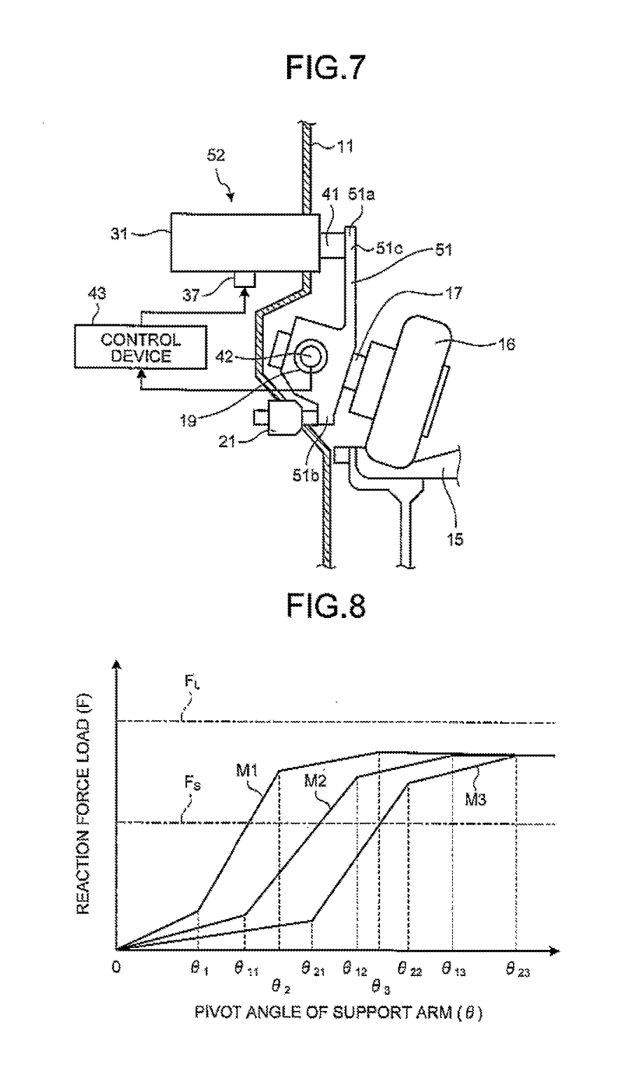

FIG. 7 is a schematic diagram illustrating a support structure of a mill roller provided in a vertical mill according to a second embodiment of the present invention. It should be noted that members having the same functions as those of the embodiment explained above are denoted with the same reference numerals, and detailed description thereabout is omitted.

In the vertical mill of the second embodiment, as illustrated in FIG. 7, a mill table 15 is installed in a housing 11, and can be driven and rotated. The mill table 15 is provided with multiple mill rollers 16 so as to face the upper side, and the mill roller 16 is rotatably supported by a first support shaft 11. A support arm 51 is supported on the housing 11 by a second support shaft 19 so as to be able to swing in the vertical direction, and the support arm 51 supports the base end portion of the first support shaft 17 of which distal end portion is attached to the mill roller 16.

This support arm 51 is provided with a reaction force load giving device 52 for giving reaction force load of each of the mill rollers 16 to an upper end portion 51a, and each support arm 51 is also provided with a stopper 21. This reaction force load giving device 52 is to cause the support arm 51 to give the reaction force load to the mill roller 16, wherein the reaction force load is in a direction against the direction in which the mill roller 16 moves away from the mill table 15, and is constituted by a dumper 31 filled with a magnetorheological fluid 35. The support arm 51 functions as a returning device for causing the mill roller 16 back to the initial position where the mill roller 16 is close to the mill table 15. More specifically, in the support arm 51, an arm portion 52c extending from the second support shaft 19 to the upper side functions as an elastic member, and the arm portion 51c urges and supports the support arm 51 in the clockwise direction in FIG. 7, i.e., the direction in which the mill roller 16 comes closer to the mill table 15. In this case, in order to ensure sufficient rigidity of the arm portion 51c, the arm portion 51c is preferably made to be thick in the thickness direction (direction perpendicular to the page in FIG. 7), and is made to be thin in the width direction (the horizontal direction of FIG. 7). In the dumper 31, a pressing unit 41 is in contact with the upper end portion 51a of the support arm 51. Alternatively, in the dumper 31, the pressing unit 41 may be coupled with the upper end portion 51a of the support arm 51.

A pivot angle sensor 42 is provided between the support arm 51 and the second support shaft 19, and the pivot angle sensor 42 detects the pivot angle of the support arm 51. A control device 43 controls the reaction force load giving device 52 on the basis of the detection value of the pivot angle sensor 42, and adjusts the reaction force load of the mill roller 16. More specifically, when the pivot angle of the support arm 51 with respect to the initial position increases, i.e., when the mill roller 16 ascends from the initial position with respect to the mill table 15, then, the control device 43 increases the reaction force load of the mill roller 16.

Therefore, when the solid object is provided to the central portion of the mill table 15, this solid object provided to the central portion on the mill table 15 disperses and moves to the external periphery by the centrifugal force, and the solid object enters into between each of the mill rollers 16 and the mill table 15. Then, the rotation force of the mill table 15 is transmitted via the solid object to each of the mill rollers 16, and according to the rotation of the mill table 15, the mill roller 16 rotates. At this occasion, each of the mill rollers 16 tries to ascend due to the solid object, but because the reaction force load giving device 52 gives the reaction force load, the ascending operation is suppressed, and the pressing load is given to the solid object. Therefore, each of the mill rollers 16 presses and mills the solid object on the mill table 15. At this occasion, although each of the mill rollers 16 slightly ascends against the reaction force load depending on the size and the hardness of the solid object entering into between the mill roller 16 and the mill table 15, each of the mill rollers 16 is returned back to the initial position due to the weight of the mill roller 16 of its own when the solid object is milled, and at the same time, the support arm 51 returns back to the initial position due to the elastic force of the arm portion 51c.

As described above, the vertical mill according to the second embodiment is configured such that the reaction force load giving device 52 is provided to give the reaction force load to the mill roller 16 via the support arm 31, and the arm portion 51c of the support arm 51 is made as the elastic member, which serves as the returning device for returning the mill roller 16 hack to the initial position where the mill roller 16 is close to the mill table 15.

Therefore, without providing a separate member such as a spring as the returning device, the arm portion 51c of the support am 51 is caused to function as the elastic member, so that the structure can be simplified, and the cost can be reduced.

### Third Embodiment

FIG. 8 is a graph illustrating the reaction force load of a mill roller imposed on the pivot angle of a support arm in a vertical mill according to a third embodiment of the present invention. It should be noted that the basic configuration of the vertical mill of the present embodiment is substantially the same as the configuration of the first embodiment explained above, and the third embodiment will be explained with reference to FIG. 3, and members having the same functions as those of the embodiment explained above are denoted with the same reference numerals, and detailed description thereabout is omitted.

In the vertical mill of the third embodiment, as illustrated in FIG. 3, a mill table 15 is installed in a housing 11, and can be driven and rotated. The mill table 15 is provided with multiple mill rollers 16 so as to face the upper side, and the mill roller 16 is rotatably supported by a first support shaft 17. A support arm 18 is supported on the housing 11 by a second support shaft 19 so as to be able to swing in the vertical direction, and the support arm 18 supports the base end portion of the first support shaft 17 of which distal end portion is attached to the mill roller 16.

This support arm 18 is provided with a reaction force load giving device 20 for giving reaction force load of each of the mill rollers 16 to an upper end portion 18a, and each of the support arms 18 is also provided with a stopper 21 at a lower end portion 18a. This reaction force load giving device 20 is to cause the support arm 18 to give the reaction force load to the mill roller 16, wherein the reaction force load is in a direction against the direction in which the mill roller 16 moves away from the mill table 15, and is constituted by a dumper 31 filled with a magnetorheological fluid 35. The reaction force load giving device 20 includes not only the dumper 31 but also a compression coil spring 38 serving as a returning device for returning the mill roller 16 back to the initial position where the mill roller 16 is close to the mill table 15.

A pivot angle sensor 42 is provided between the support arm 18 and the second support shaft 19, and the pivot angle sensor 42 detects the pivot angle of the support arm 18. The control device 43 controls the reaction force load giving device 20 on the basis of the detection value of the pivot angle sensor 42, and adjusts the reaction force load of the mill roller 16. More specifically, when the pivot angle of the support arm 18 with respect to the initial position increases, i.e., when the mill roller 16 ascends from the initial position with respect to the mill table 15, then, the control device 43 increases the reaction force load of the mill roller 16.

In this case, the control device 43 uses the map of FIG. 8 to set the reaction force load of the mill roller 16. More specifically, as illustrated in FIG. 8, the control device 43 sets the reaction force load of the mill roller 16 given by the reaction force load giving device 20 on the basis of the pivot angle of the support arm 18, but in the present embodiment, there are three mill rollers 16 provided, and therefore, three types of relationship graphs M1, M2 and M3 are set to show the reaction force load of the mill roller 16 and the pivot angle of the support arm 18. More specifically, in this map, when the pivot angle of the support arm 18 is pivot angles θ₁, θ₁₁ and θ₂₁, the size of the reaction force load F is the same, and when the pivot angle of the support arm 18 is pivot angles θ₂, θ₁₂ and θ₂₂, the size of the reaction force load F is the same, and when the pivot angle of the support arm 18 is pivot angles θ₃, θ₁₃ and θ₂₃, the sire of the reaction force load F is the same, but the timing with which the increasing rate of the reaction force load F is changed is different. Therefore, the reaction force load giving device 20 is configured such that the reaction force loads of the three mill rollers 16 are different.

Therefore, when the solid object is provided to the central portion of the mill table 15, this solid object disperses and moves to the external peripheral side due to the centrifugal force, and the solid object enters into between the mill roller 16 and the mill table 15. Then, the rotation force of the sill table 15 is transmitted via the solid object to each of the mill rollers 16, and according to the rotation of the mill table 15, the mill roller 16 rotates. At this occasion, each of the mill rollers 16 tries to ascend due to the solid object, but because the reaction force load giving device 20 gives the reaction force load, the ascending operation is suppressed, and the pressing load is given to the solid object. Therefore, each of the mill rollers 16 presses and mills the solid object on the mill table 15. Different levels of reaction force loads are exerted on the three mill rollers 16, and therefore, even when solid objects of different sizes and hardness are provided, each of the mill rollers 16 appropriately mills the solid objects of different sizes and hardness.

As described above, the vertical mill according to the third embodiment is configured such that, above the mill table 15, the three mill rollers 16 are provided with a regular interval along the peripheral direction, and the reaction force load giving device 20 is configured such that the reaction force load for each of the mill rollers 16 is different.

Therefore, the multiple mill rollers 16 can give appropriate pressing load to solid objects each of which is of different size and hardness, thus capable of milling the solid object in a reliable manner.

### Fourth Embodiment

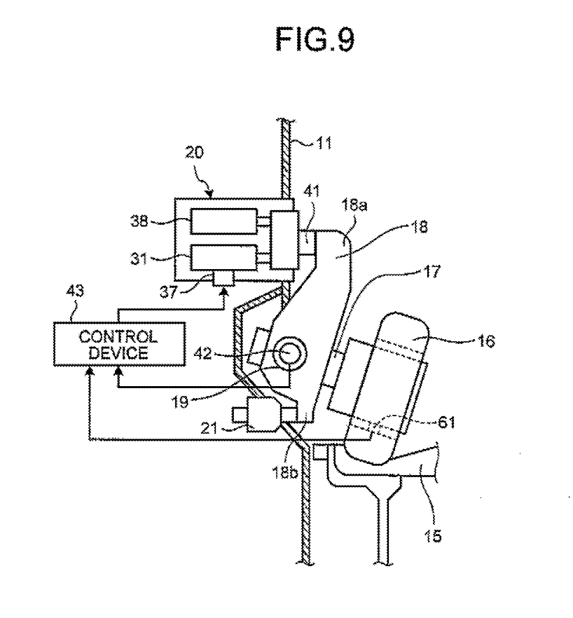

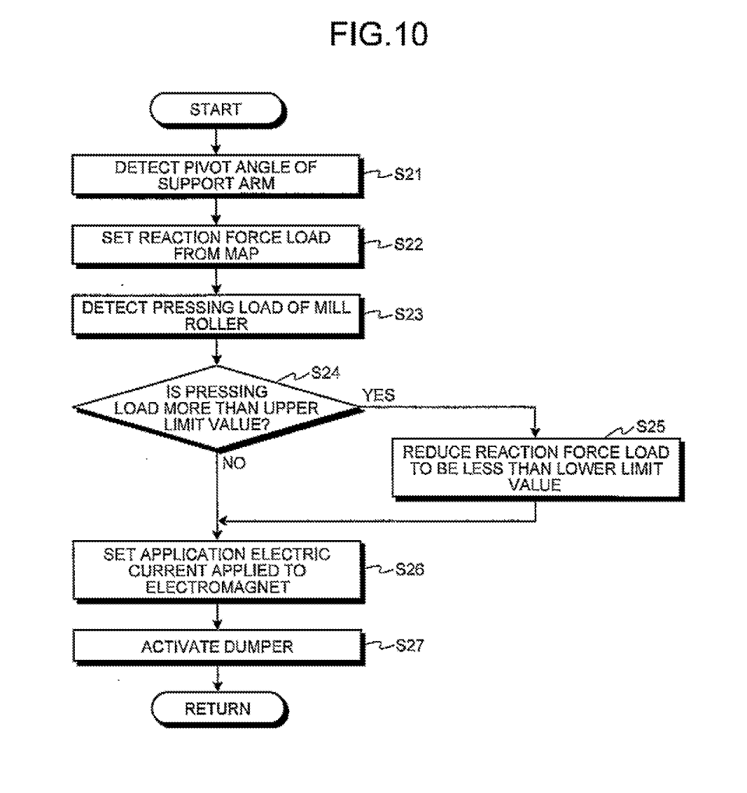

FIG. 9 is a schematic diagram illustrating a support structure of a mill roller in a vertical mill according to a fourth embodiment of the present invention. FIG. 10 is a flowchart illustrating processing for setting reaction force load of a mill roller provided in a vertical mill according to the fourth embodiment. It should be noted that members having the same functions as those of the embodiment explained above are denoted with the same reference numerals, and detailed description thereabout is omitted.

In the vertical mill of the fourth embodiment, as illustrated in FIG. 9, a mill table 15 is installed in a housing 11, and can be driven and rotated. The mill table 15 is provided with multiple mill rollers 16 so as to face the upper side, and the mill roller 16 is rotatably supported by a first support shaft 17. A support arm 18 is supported on the housing 11 by a second support shaft 19 so as to be able to swing in the vertical direction, and the support arm 18 supports the base end portion of the first support shaft 17 of which distal end portion is attached to the mill roller 16.

This support arm 18 is provided with a reaction force load giving device 20 for giving reaction force load of each of the mill rollers 16 to an upper end portion 18a, and each of the support arms 18 is also provided with a stopper 21 at a lower end portion 18b. This reaction force load giving device 20 is to cause the support arm 18 to give the reaction force load to the mill roller 16, wherein the reaction force load is in a direction against the direction in which the mill roller 16 moves away from the mill table 15, and is constituted by a dumper 31 filled with a magnetorheological fluid 35. The reaction force load giving device 20 includes not only the dumper 31 but also a compression coil spring 38 serving as a returning device for returning the mill roller 16 hack to the initial position where the mill roller 16 is close to the mill table 15.

A pivot angle sensor 42 is provided between the support arm 18 and the second support shaft 19, and the pivot angle sensor 42 detects the pivot angle of the support arm 18. A control device 43 controls the reaction force load giving device 20 on the basis of the detection value of the pivot angle sensor 42, and adjusts the reaction force load of the mill roller 16. Here specifically, when the pivot angle of the support arm 18 with respect to the initial position increases, i.e., when the mill roller 16 ascends from the initial position with respect to the mill table 15, then, the control device 43 increases the reaction force load of the mill roller 16.

A load sensor (detection device) 61 is provided between the mill roller 16 and the first support shaft 17 to detect the pressing load of the mill roller 16 onto the still table 15. The control device 43 controls the reaction force load giving device 20 on the basis of the detection value of the load sensor 61, and adjusts the reaction force load of the mill roller 16. More specifically, when the pressing load of the mill roller 16 is more than a upper limit value (predetermined value) which has been set in advance, the control device 43 reduces the reaction force load given by the reaction force load giving device 20 so that the reaction force load given by the reaction force load giving device 20 becomes less than a lower limit value (reference value) which has been set in advance.

More specifically, when the solid object enters into the gap between the mill roller 16 and the mill table 15, the mill roller 16 ascends due to the solid object, and therefore, the reaction force load giving device 20 increases the reaction force load of the mill roller 16, so that the pressing load onto the solid object increases, and the solid object is appropriately milled. However, when the solid object is spillage, and the mill roller 16 cannot mill the solid object, then the mill roller 16 ascends due to this solid object (spillage), and the reaction force load giving device 20 increases the reaction force load of the mill roller 16. At this occasion, excessive force is exerted on the mill roller 16 and the mill table 15, and the solid object (spillage) cannot be milled, and the mill roller 16 and the mill table 15 may be damaged. For this reason, when the pressing load of the mill roller 16 exceeds the upper limit value at which the mill roller 16 and the mill table 15 are damaged, the control device 43 reduces the reaction force load given by the reaction force load giving device 20 so that it is less than the lower limit value at which the spillage can easily pass through between the mill roller 16 and the mill table 15.

In the above explanation, the load sensor 61 for detecting the pressing load of the mill roller 16 imposed on the mill table 15 is used as the detection device, but the present invention is not limited thereto. For example, a sensor for detecting the load and the deformation (distortion) of the first support shaft 17 and the support arm 18, or the pivot angle sensor 42 for detecting the pivot angle of the support arm 18 may be used as the detection device.

Therefore, when the solid object is provided to the central portion on the mill table 15, the solid object disperses and moves to the external periphery by the centrifugal force, and enters into between the mill roller 16 and the mill table 15. Then, the rotation force of the mill table 15 is transmitted via the solid object to each of the mill rollers 16, and according to the rotation of the mill table 15, the mill roller 16 rotates. At this occasion, each of the mill rollers 16 tries to ascend due to the solid object, but because the reaction force load giving device 20 gives the reaction force load, the ascending operation is suppressed, and the pressing load is given to the solid object. Therefore, each of the mill rollers 16 presses and mills the solid object on the mill table 15.

While the mill roller 16 mills the solid object as described above, the control device 43 controls the reaction force load giving device 20 on the basis of the detection values of the pivot angle sensor 42 and the load sensor 61, and adjusts the reaction force load of the mill roller 16. More specifically, as illustrated in FIG. 10, in step S21, the pivot angle sensor 42 detects the pivot angle of the support arm 18, and in step S22, the control device 43 sets the reaction, force load of the mill roller 16 on the basis of the pivot angle of the support arm 18.

Then, in step S23, the load sensor 61 detects the pressing load of the mill roller 16 onto the mill table 15, and in step S24, the control device 43 determines whether the pressing load of the mill roller 16 exceeds the upper limit value. In this case, when the pressing load of the mill roller 16 is determined not to exceed the upper limit value, step S26 is subsequently performed, and when the pressing load of the mill roller 16 is determined to exceed the upper limit value, the reaction force load of the mill roller 16 which has been step in step S22 is reduced to be less than the lower limit value in step S25, and subsequently, step S26 is performed.

Then, in step S26, the reaction force load giving device 20 sets the application electric current which a power supply device 37 applies to an electromagnet 36. In step S27, the control device 43 controls the power supply device 37, and applies a predetermined electric current to the electromagnet 36, so that the magnetorheological fluid 35 is magnetized, and the dumper 31 is activated, and the predetermined reaction force load is exerted on the mill roller 16.

Therefore, when the solid object enters into between each of the mill rollers 16 and the mill table 15, the mill roller 16 ascends, and accordingly, the reaction force load of the mill roller 16 increases, and the solid object is milled by giving the pressing load to the solid object. When the mill roller 16 mills the solid object, the mill roller 16 descends, and therefore the reaction force load of the mill roller 16 decreases, and the mill roller 16 returns back to the initial position by its own weight, and the support arm 18 returns back to the initial position due to the urging force of the compression coil spring 38. As a result of the repetition thereof, the mill roller 16 mills the solid object continuously.

On the other hand, when the solid object enters into between each of the mill rollers 16 and the mill table 15, the mill roller 16 greatly ascends, and the pressing load increases. Therefore, the reaction force load of the mill roller 16 decreases, and accordingly, the spillage easily passes through between each of the mill rollers 16 and the mill table 15, and the mill roller 16 and the mill table 15 are not damaged.

In the vertical mill according to the fourth embodiment explained above, when the solid object enters info between the mill roller 16 and the mill table 15, and the pressing load of the mill roller 16 exceeds the upper limit value, then the reaction force load of the mill roller 16 is reduced.

Therefore, when a foreign object that cannot be milled into between the mill roller 16 and the mill table 15, the pressing load of the mill roller 16 onto the mill table 15 increases to be more than the upper limit value, and therefore, at this occasion, the reaction force load of the mill roller 16 is reduced to be less than the lower limit value, so that this can prevent the mill roller 16 and the mill table 15 from being damaged in advance.

### Fifth Embodiment

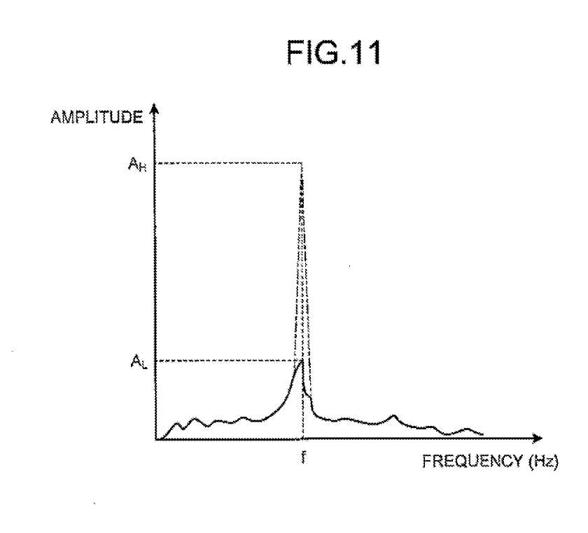

FIG. 11 is a graph illustrating amplitude with respect to a vibration frequency of a mill roller provided in a vertical mill according to a fifth embodiment of the present invention. It should be noted that the basic configuration of the vertical mill of the present embodiment is substantially the same as the configuration of the first embodiment explained above, and the fifth embodiment will be explained with reference to FIG. 3, and members having the same functions as those of the embodiment explained above are denoted with the same reference numerals, and detailed description thereabout is omitted.

In the vertical mill of the fifth embodiment, as illustrated in FIG. 3, a mill table 15 is installed in a housing 11, and can be driven and rotated. The mill table 15 is provided with multiple mill rollers 16 so as to face the upper side, and the mill roller 16 is rotatably supported by a first support shaft 17. A support arm 18 is supported on the housing 11 by a second support shaft 19 so as to be able to swing in the vertical direction, and the support arm 18 supports the base end portion of the first support shaft 17 of which distal end portion is attached to the mill roller 16.

This support arm 18 is provided with a reaction force load giving device 20 for giving reaction force load of each of the mill rollers 16 to an upper end portion 18a, and each of the support arms 18 is also provided with a stopper 21 at a lower end portion 18b. This reaction force load giving device 20 is to cause the support arm 18 to give the reaction force load to the mill roller 16, wherein the reaction force load is in a direction against the direction in which the mill roller 16 moves away from the mill table 15, and is constituted by a dumper 31 filled with a magnetorheological fluid 35. The reaction force load giving device 20 includes not only the dumper 31 but also a compression coil spring 38 serving as a returning device for returning the mill roller 16 back to the initial position where the mill roller 16 is close to the mill table 15.

A pivot angle sensor 42 is provided between the support arm 18 end the second support shaft 19, and the pivot angle sensor 42 detects the pivot angle of the support arm 18. A control device 43 controls the reaction force load giving device 20 on the basis of the detection value of the pivot angle sensor 42, and adjusts the reaction force load of the mill roller 16. More specifically, when the pivot angle of the support arm 18 with respect to the initial position increases, i.e., when the mill roller 16 ascends from the initial position with respect to the mill table 15, then, the control device 43 increases the reaction force load of the mill roller 16.

When the oscillation of the mill roller 16 enters into the resonance range, the control device 43 increases the reaction force load given by the reaction force load giving device 20. More specifically, when the vibration of the mill roller 16 is expected to enter Into the resonance range in which it is resonant with the vibration of the mill table 15 immediately after the start of operation of the vertical mill or immediately before the stop of the operation of the vertical mill, the reaction force load is exerted on the mill roller 16 by the reaction force load giving device 20 in advance. With this operation, the resonance of the mill roller 16 and the mill table 15 is suppressed, and the mill roller 16 and the mill table 15 are prevented from being damaged.

As a result, as illustrated in FIG. 11, when the resonant points of the mill roller 16 and the mill table 15 are the same at a predetermined frequency f, the reaction force load is exerted on the mill roller 16 by the reaction force load giving device 20, so that an amplitude &s can be reduced to an amplitude A_{L}.

In the vertical mill according to the fifth embodiment explained above, when the vibration of the mill roller 16 enters into the resonance range, the reaction force load given by the reaction force load giving device 20 is increased.

Therefore, when the vibration of the mill roller 16 enters into the resonance range, the reaction force load is increased, so that this suppresses the vibration of the mill roller 16 and the mill table 15, thus preventing the mill roller 16 and the mill table 16 from being damaged,

In each embodiment explained above, three mill rollers 16 are provided for one mill table 15, but the number of the mill rollers 16 is not limited thereto. In the embodiment, the sill roller 16 is in a tire shape, but the mill roller 16 may be in the circular truncated cone shape in which the diameter decreases at the distal end portion. However, the mill roller 16 is not limited to this shape.

### REFERENCE SIGNS LIST

11 HOUSING

13 SOLID OBJECT PROVIDING PIPE

15 MILL TABLE

16 MILL ROLLER

17 FIRST SUPPORT SHAFT

18, 51 SUPPORT ARM

19 SECOND SUPPORT SHAFT

20, 52 REACTION FORCE LOAD GIVING DEVICE

21 STOPPER

38 COMPRESSION COIL SPRING (RETURNING DEVICE)

42 PIVOT ANGLE SENSOR (DETECTION DEVICE)

43 CONTROL DEVICE

61 LOAD SENSOR (DETECTION DEVICE)

1. A vertical mill comprising:
a housing having a hollow shape;
a mill table rotatably supported in the housing by a support shaft center along a vertical direction;
a mill roller provided above the mill table and rotatably supported by a first support shaft, the mill roller being capable of rotating with an external peripheral surface of the mill roller coming into contact with an upper surface of the mill table;
a support arm for supporting the first support shaft, the support arm being swingably supported on the housing by a second support shaft with the external peripheral surface of the mill roller coming close to or moving away from the upper surface of the mill table; and
a reaction force load giving device having a dumper filled with a magnetorheological fluid and magnetizing the magnetorheological fluid so as to give a reaction force load to the mill roller via the support arm, the reaction force load being given against a direction in which the mill roller moves away from the mill table.

2. The vertical mill according to claim 1, wherein the mill roller is provided with a returning device for returning the mill roller back to an initial position where the mill roller is close to the mill table.

3. The vertical mill according to claim 1 further comprising:
a detection device for detecting a position of the mill roller with respect to the mill table or a pressing load of the mill roller onto the mill table; and
a control device for increasing the reaction force load given by the reaction force load giving device in accordance with increase of a detection value of the detection device.

4. The vertical mill according to claim 3, wherein when the detection value of the detection device is more than a predetermined value which has been set in advance, the control device is configured to reduce the reaction force load given by the reaction force load giving device so that the reaction force load given by the reaction force load giving device is less than a reference value which has been set in advance.

5. The vertical mill according to claim 3, wherein when a vibration of the mill roller enters into a resonance range, the control device is configured to increase a reaction force load given by the reaction force load giving device.

6. The vertical mill according to claim 1, wherein a plurality of mill rollers and support arms are provided with a regular interval along a peripheral direction of the mill table, and
the reaction force load giving device is configured to differentiate reaction force loads of the plurality of mill rollers.
